(19) United States
(12) Patent Application Publication
(10) Pub. No.: US 2026/0228630 A1
(43) Pub. Date: Aug. 6, 2026

(54) INFORMATION PROCESSING APPARATUS, INFORMATION PROCESSING METHOD, STORAGE MEDIUM, AND SYSTEM FOR FEDERATED LEARNING

(71) Applicant: CANON KABUSHIKI KAISHA, Tokyo (JP)

(72) Inventor: HAJIME MUTA, Kanagawa (JP)

(21) Appl. No.: 19/455,575

(22) Filed: Jan. 21, 2026

(30) Foreign Application Priority Data
Jan. 31, 2025 (JP) 2025-014926

(51) Int. Cl. G06N 20/00

(52) U.S. Cl. CPC G06N 20/00

(57) ABSTRACT

An information processing apparatus includes at least one processor, and at least one memory having instructions stored therein which, when executed by the at least one processor, cause the information processing apparatus to acquire an input image, store an inference model and a local inference parameter to be applied to the inference model, and acquire an inference result from the inference model by inputting the acquired input image to the inference model and applying the local inference parameter thereto, acquire, from a user, correction information representing a correction result that corrects the inference result, and execute a learning process on the inference model based on the input image and the correction information.

### BACKGROUND

### Field of the Technology

The present disclosure relates to an information processing apparatus, an information processing method, a storage medium, and a system.

### Description of the Related Art

Artificial intelligence (AI) using machine learning that uses deep learning is being actively developed, and many apparatuses powered by AI are put to practical use. In AI development, a large amount of learning data is collected, and then, the training (the learning) of a learning model using the learning data is performed by, for example, machine learning. There is also an increase in regulations for data security, privacy protection, and the like. There is even a case where it is difficult to collect learning data. Federated learning is a technique for using learning data that is difficult to collect due to these regulations for data security, privacy protection, and the.

In federated learning, a server managed by an AI developer and one or more clients holding learning data difficult for the AI developer to collect collaborate to achieve the training of a learning model using a large amount of learning data.

Specifically, the server transmits a learning model stored on the server to each client that stores learning data. Each client uses the learning model transmitted from the server as an initial value, trains the learning model using the learning data stored by the client, and transmits the learning result to the server. The server receives the learning result from each client and integrates the plurality of learning results, thereby updating the learning model stored in the server.

Federated learning results in the server not needing to collect learning data, and the clients do not need to mutually refer to learning data, either. Thus, even if it is difficult to collect learning data, it is possible to achieve training using learning data.

U.S. Pat. No. 11,763,197 describes a system for achieving federated learning and a method for efficiently transmitting a learning result from a client to a server.

Japanese Patent Laid-Open No. 2024-006291 describes a system for transmitting local data information indicating the characteristics of learning data stored in clients in addition to learning results from the clients to a server to eliminate the imbalance between the numbers of pieces of data stored in the clients.

On the other hand, there is a case where the generation of learning data requires cumbersome work of assigning, to a target of inference by a learning model (hereinafter also referred to as an “inference model”) in data as a target, supervised data that is a correct answer to the inference as an annotation. Such an issue can be actualized not only in the application of federated learning, but also in a situation where a user generates learning data in a local environment of an individual client.

### SUMMARY

The present disclosure is directed to reducing the burden on a user regarding the generation of learning data for use in machine learning in a more suitable form.

According to an aspect of the present disclosure, an information processing apparatus includes at least one processor, and at least one memory having instructions stored therein which, when executed by the at least one processor, cause the information processing apparatus to acquire an input image, store an inference model and a local inference parameter to be applied to the inference model, and acquire an inference result from the inference model by inputting the acquired input image to the inference model and applying the local inference parameter thereto, acquire, from a user, correction information representing a correction result that corrects the inference result, and execute a learning process on the inference model based on the input image and the correction information.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a hardware configuration of an imaging apparatus.

FIGS. 2A and 2B are diagrams illustrating examples of a functional configuration of the imaging apparatus.

FIG. 3 is a diagram illustrating an example of processing of the imaging apparatus.

FIGS. 4A to 4I are diagrams illustrating examples of a display method for a focus point based on an inference result.

FIGS. 5A to 5C are diagrams illustrating examples of a correction operation on an inference result.

FIGS. 6A to 6D are diagrams illustrating an example of processing of the imaging apparatus.

FIG. 7 is a diagram illustrating an example of a hardware configuration of a server.

FIG. 8 is a diagram illustrating an example of a functional configuration of a federated learning system.

FIG. 9 is a diagram illustrating an example of processing of the federated learning system.

### DESCRIPTION OF THE EMBODIMENTS

Embodiments of the present disclosure will be described in detail below with reference to the accompanying drawings.

In this specification and the drawings, components having substantially the same functional configuration are denoted by the same reference numerals, and redundant descriptions are omitted.

### First Embodiment

As a first embodiment of the present disclosure, a description is given of an example of a case where a technique according to the present disclosure is applied to an imaging apparatus such as a digital still camera, a digital video camera, or the like.

### (Hardware Configuration)

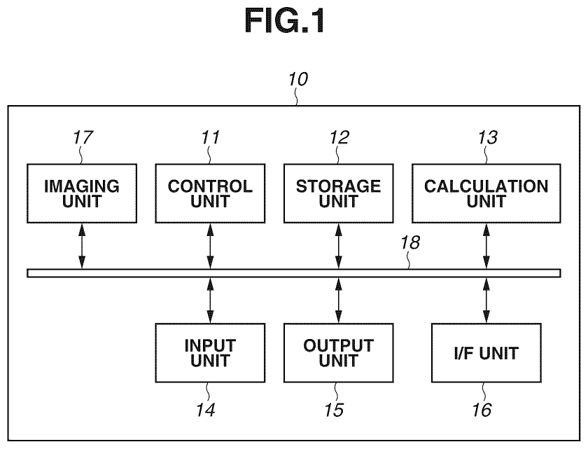

With reference to FIG. 1, an example of the hardware configuration of the imaging apparatus according to the first embodiment of the present disclosure is described. An imaging apparatus 10 includes a control unit 11, a storage unit 12, a calculation unit 13, an input unit 14, an output unit 15, an interface (I/F) unit 16, an imaging unit 17, and a system bus 18.

The control unit 11 controls the entirety of the imaging apparatus 10.

The storage unit 12 holds a program and data for realizing the operation of the control unit 11.

The calculation unit 13 executes various calculation processes based on control of the control unit 11. As the calculation unit 13, for example, a central processing unit (CPU), a graphics processing unit (GPU), or the like can be applied. As the calculation unit 13, a Tensor Processing Unit (TPU), a vision processing unit (VPU), or the like may be applied.

The input unit 14 receives the input of a user operation on the imaging apparatus 10. As the input unit 14, for example, a mechanical button and a mechanical switch mounted on the imaging apparatus 10, a touch panel mounted on a back surface display of the imaging apparatus 10, or the like can be applied. As the input unit 14, a remote operation device such as a remote controller, a smartphone, a tablet, or the like connected to the imaging apparatus 10 may be applied.

The output unit 15 presents information regarding the processing result of the imaging apparatus 10 or the like to a user. As the output unit 15, for example, a back surface display, an electronic viewfinder, or the like can be applied. As the output unit 15, a display device such as an external display, a smartphone, a tablet, or the like connected to the imaging apparatus 10 may be applied.

The I/F unit 16 corresponds to an interface for receiving programs, data, and the like for realizing various operations of the imaging apparatus 10 from outside or transmitting various pieces of information regarding the processing result obtained by the imaging apparatus 10 and the like to outside. Examples of the I/F unit 16 include interfaces compliant with various standards such as Universal Serial Bus (USB), Wi-Fi (registered trademark), Bluetooth®, and the like.

The imaging unit 17 acquires an input image for use in various processes of the imaging apparatus 10. As the imaging unit 17, a solid-state image sensor such as a complementary metal-oxide-semiconductor (CMOS) sensor or the like can be applied. As the imaging unit 17, a solid-state image sensor such as a charge-coupled device (CCD) sensor, a single-photon avalanche diode (SPAD) sensor, or the like may be applied.

The control unit 11, the storage unit 12, the calculation unit 13, the input unit 14, the output unit 15, the I/F unit 16, and the imaging unit 17 are connected together via the system bus 18 so that these units can transmit and receive information to and from each other.

### (Functional Configuration)

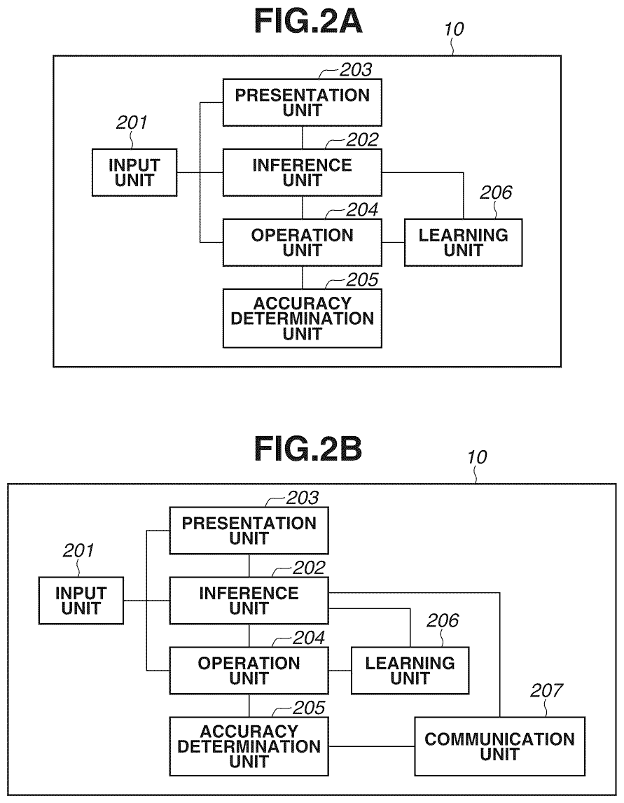

With reference to FIGS. 2A and 2B, examples of the functional configuration of the imaging apparatus according to the present embodiment are described.

First, a configuration illustrated in FIG. 2A is described. The imaging apparatus 10 illustrated in FIG. 2A includes an input unit 201, an inference unit 202, a presentation unit 203, an operation unit 204, a learning unit 206, and an accuracy determination unit 205.

The input unit 201 acquires an image as a target of image processing performed by the imaging apparatus 10 as an input image.

The inference unit 202 holds an inference model and an inference parameter to be applied when the inference model performs inference. The inference unit 202 inputs the input image acquired by the input unit 201 to the inference model to which the inference parameter is applied, thereby acquiring an inference result of the inference model. In the present disclosure, an inference parameter stored in the inference unit 202 is also referred to as a “local inference parameter” for convenience.

The presentation unit 203 outputs information regarding an output target such as the input image acquired by the input unit 201, the inference result obtained by the inference unit 202, or the like to a predetermined output destination (e.g., the output unit 15), thereby presenting the information to the user.

The operation unit 204 receives an operation of the user through a predetermined device (e.g., the input unit 14) and acquires information according to the content of the operation. For example, if the operation unit 204 detects a correction operation of the user, the operation unit 204 corrects the inference result of the inference model obtained by the inference unit 202 and acquires the result of the correction as correction information. If the operation unit 204 detects an operation of saving the input image performed by the user, the operation unit 204 saves the input image as the target. At this time, if the correction information is present, the operation unit 204 may save the correction information in association with the input image as the target.

The accuracy determination unit 205 determines the accuracy of the inference parameter based on the inference result obtained by the inference unit 202 and the correction information acquired by the operation unit 204 and acquires the result of the determination (hereinafter also referred to as the “accuracy determination result”).

The learning unit 206 updates the inference parameter (the local inference parameter) stored in the inference unit 202 based on the input image acquired by the input unit 201 and the correction information acquired by the operation unit 204.

Next, with reference to FIG. 2B, a description is given of an example of the functional configuration in a case where a communication unit 207 is added to the imaging apparatus 10 illustrated in FIG. 2A.

The communication unit 207 transmits the local inference parameter stored in the inference unit 202 and the accuracy determination result acquired by the accuracy determination unit 205 to outside (e.g., an external apparatus such as a server 20 or the like). The communication unit 207 also receives a global inference parameter from outside and replaces the local inference parameter stored in the inference unit 202 with the global inference parameter.

The imaging apparatus 10 illustrated in each of FIGS. 2A and 2B corresponds to an example of an information processing apparatus according to the present embodiment.

### (Processing)

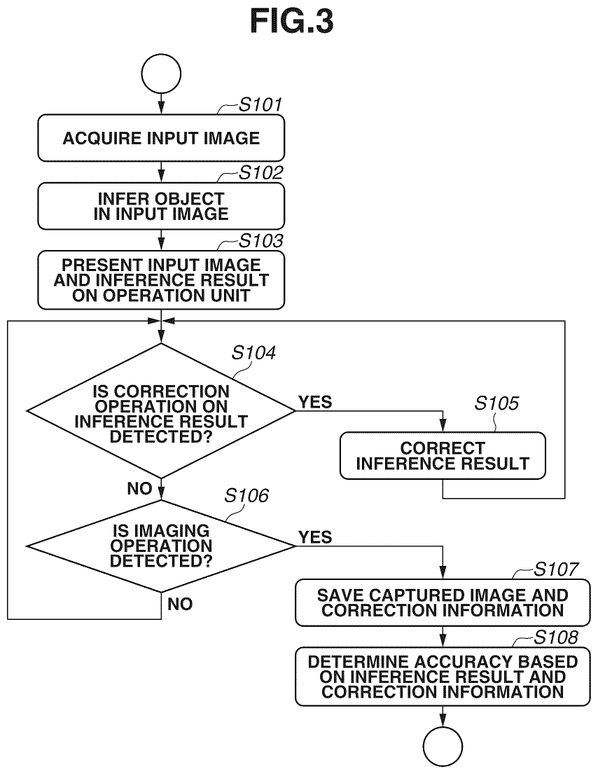

With reference to FIG. 3, an example of the processing of the imaging apparatus according to the present embodiment is described.

In step S101, the input unit 201 acquires an image, which is a target of image processing performed by the imaging apparatus 10, as an input image from the imaging unit 17.

In step S102, the inference unit 202 holds an inference model and a local inference parameter regarding the inference model. Then, the inference unit 202 uses the input image acquired by the input unit 201 in step S101 as a target and executes an inference process in the calculation unit 13 using the inference model and the local inference parameter stored in the inference unit 202, thereby acquiring an inference result.

The “inference model” refers to a model in which an algorithm executable by the calculation unit 13 is defined so that the inference unit 202 executes the inference process.

The “local inference parameter” refers to a parameter determining the content of the inference process based on the algorithm included in the inference model. The local inference parameter is updated, whereby it is possible to cause the inference model to perform a variety of inference processes.

In the present disclosure, “local” in the local inference parameter is used in the sense that the inference parameter is used inside the imaging apparatus 10.

As the inference model, a variety of known inference models capable of updating the local inference parameter can be used. Examples of the inference model include a neural network.

Examples of the neural network include a convolutional neural network, a deconvolutional neural network, an autoencoder, a transformer, and the like.

More specific examples of the neural network include U-Net, a residual neural network (ResNet), and the like.

If the inference model is a neural network, the local inference parameter corresponds to a weight, a bias, or the like of the neural network.

As the inference model and the local inference parameter, for example, the inference model and the local inference parameter saved in advance in the storage unit 12 may be used, or the inference model and the local inference parameter may be received from an external device connected to the I/F unit 16 and saved in the storage unit 12.

The inference unit 202 causes an inference model to read a local inference parameter saved in the storage unit 12 and then inputs the input image acquired by the input unit 201 to the inference model, thereby being able to obtain an inference result as the output of the inference model.

In step S103, the presentation unit 203 outputs the input image acquired by the input unit 201 and the inference result obtained by the inference unit 202 to the output unit 15, thereby presenting the input image and the inference result to the user. For example, the presentation unit 203 displays on the back surface display the input image on which the inference result is superimposed. The imaging apparatus 10 may output the input image and the inference result to an external apparatus such as an external display, a mobile apparatus, e.g., a smartphone or a tablet, or the like connected to the I/F unit 16 instead of the presentation unit 203, thereby presenting information regarding the input image and the inference result to the user.

In step S104, the operation unit 204 determines whether a correction operation of the user on the inference result of the inference unit 202 presented by the presentation unit 203 is detected through the input unit 14.

The correction operation can correspond to, for example, an act of pressing cursor keys mounted on the imaging apparatus 10 so that the user corrects the inference result displayed on the back surface display, or the like.

If the operation unit 204 determines in step S104 that the correction operation is detected (YES in step S104), the processing proceeds to step S105.

If, on the other hand, the operation unit 204 determines in step S104 that the correction operation is not detected (NO in step S104), the processing proceeds to step S106.

In step S105, based on the correction operation of the user, the operation unit 204 corrects the inference result obtained by the inference unit 202, and acquires the result of the correction as correction information.

If the inference result obtained by the inference unit 202 is corrected as a result of a cursor key operation of the user, the operation unit 204 generates correction information.

If, on the other hand, the inference result obtained by the inference unit 202 is not corrected as a result of a cursor key operation of the user, the operation unit 204 does not generate correction information. In this case, if the correction information is already generated, the operation unit 204 discards the correction information.

In step S106, the operation unit 204 determines whether an imaging operation of the user on the input image is detected.

For example, the imaging operation may correspond to a full press operation on a shutter button, a touch operation or a push-in operation on a particular area of the touch panel, or the like.

If the operation unit 204 determines in step S106 that the imaging operation of the user is detected (YES in step S106), the processing proceeds to step S107.

If, on the other hand, the operation unit 204 determines in step S106 that the imaging operation of the user is not detected (NO in step S106), the processing returns to step S104. In this case, the processes of step S104 and the subsequent steps are executed again.

In step S107, the operation unit 204 saves the above-mentioned input image.

If the correction information corresponding to the input image (the correction information generated as a result of the correction operation of the user performed on the input image) is saved, the operation unit 204 saves the saved input image and the correction information in association with each other.

The input image and the correction information may be saved in the storage unit 12, or may be saved in an external storage device or the like connected to the I/F unit 16.

In step S108, the accuracy determination unit 205 determines the accuracy of the local inference parameter based on the inference result obtained by the inference unit 202 and the correction information obtained by the operation unit 204 and acquires an accuracy determination result.

For example, the accuracy can be obtained from the number of times of the imaging operation of the user and the number of times of the correction operation of the user.

For example, if the imaging operation in step S106 is performed N times and the number of times of the imaging operation involving correction is M times out of N times, it is possible to calculate an accuracy determination result p by a calculation expression illustrated below as expression 1.

$$p = ( N - M ) / N \qquad ( expression 1 )$$

If the frequency of the correction operation of the user is low, i.e., if the correction operation does not need to be performed because the estimation accuracy of the inference unit 202 is high, the accuracy determination result p is closer to 1.

If, on the other hand, the frequency of the correction operation of the user is high, i.e., if the correction operation needs to be performed many times because the estimation accuracy of the inference unit 202 is low, the accuracy determination result p is closer to 0.

### (Setting and Correction of Focus Point)

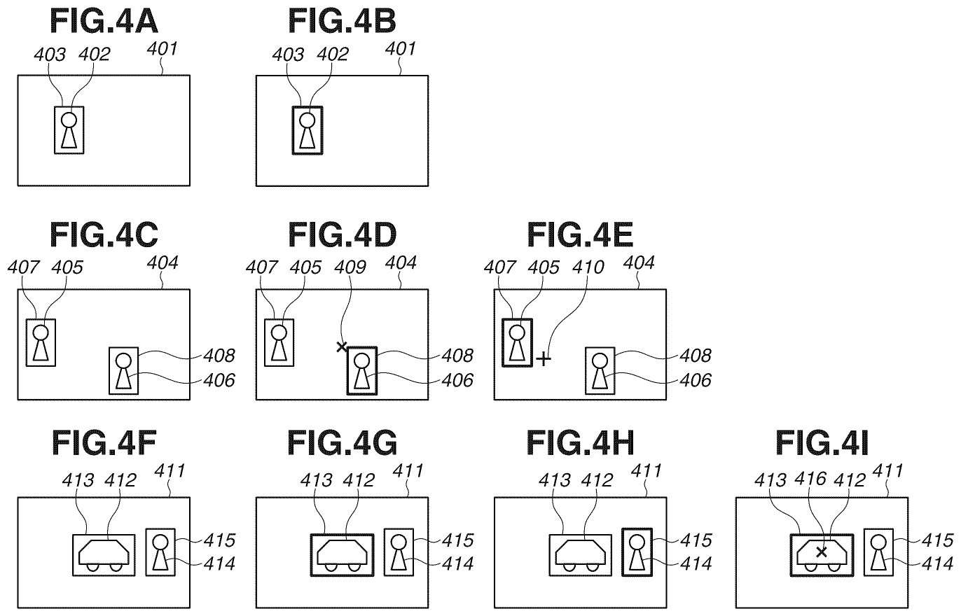

With reference to FIGS. 4A to 4I, the details of the processes of steps S102 and S105 illustrated in FIG. 3 are described taking as an example a case where a focus point set on one of a plurality of objects detected by the imaging apparatus 10 is corrected by an operation of the user.

In step S102, the inference unit 202 detects an object in an input image acquired in step S101 and sets a focus point based on the detection result. Then, the presentation unit 203 visualizes the detection result of the object and the focus point in the input image acquired by the input unit 201, superimposes the detection result of the object and the focus point on the input image, and outputs the resulting image to the output unit 15, thereby presenting the resulting image to the user.

In the example illustrated in FIG. 4A, the detection result of a person 402 as an object is visualized as a detection frame 403 in an input image 401 and displayed.

In the example illustrated in FIG. 4A, the detection frame is indicated by a rectangle surrounding the object as the target. The method for visualizing the detection result is not limited to the example where the detection frame is indicated by a rectangle surrounding the object. For example, the detection frame may be indicated by any shape/symbol displayed at the position of the object as the target.

If the inference unit 202 detects an object in an input image as a target, the inference unit 202 sets a focus point on the object based on the detection result. For example, in the example illustrated in FIG. 4A, the inference unit 202 can set the focus point at the position of the detection frame 403.

The detection frame used to set the focus point may be visualized by including information indicating that the focus point is set. FIG. 4B illustrates an example of display in this case. In the example illustrated in FIG. 4B, the detection frame 403 used to set the focus point is displayed as a thick frame.

The display of the focus point is not limited to a display method for changing the thickness of the frame, and may be another display method such as changing the color of the frame, overlaying a symbol of the focus point, displaying the detection frame in a blinking manner, or the like may be applied. As the display of the focus point, a plurality of display methods may be applied in combination. As a specific example, a display method for, in the display of the detection frame used to set the focus point, changing the thickness of the frame while changing the color of the frame and displaying the frame in a blinking manner, or the like may be applied.

As in the example illustrated in FIG. 4C, if a plurality of objects is detected in an input image 404, a detection frame corresponding to each object is displayed. Specifically, in the example illustrated in FIG. 4C, a person 405 and a person 406 are detected, and a detection frame 407 corresponding to the person 405 and a detection frame 408 corresponding to the person 406 are displayed.

As in the example illustrated in FIG. 4C, if a plurality of people (objects) is detected, for example, the focus point is narrowed down to a single location. Examples of the method for narrowing down the focus point to a single location include a method for setting the focus point on the detection frame 408 of the person 406 closest to a center 409 of the input image 404 as in the example illustrated in FIG. 4D. Examples of the method for narrowing down the focus point to a single location further include a method for setting the focus point on the detection frame 407 of the person 405 closest to a point of interest 410 set in advance by the user as in the example illustrated in FIG. 4E.

If one or more people and one or more physical objects other than people are detected in an input image, whether to give priority to a particular person or a particular physical body (e.g., a person, a vehicle, a building, an animal, a flower, or the like) as an object may be set in advance.

In the example illustrated in FIG. 4F, a detection frame 413 corresponding to a vehicle 412 and a detection frame 415 corresponding to a person 414 in an input image 411 are set.

For example, if it is set that the focus point is preferentially given to a vehicle, then as in the example illustrated in FIG. 4G, the focus point is set on the detection frame 413 corresponding to the vehicle 412.

If it is set that the focus point is preferentially given to a person, then as in the example illustrated in FIG. 4H, the focus point is set on the detection frame 415 corresponding to the person 414.

A case can also be assumed where an object to which the focus point is preferentially given is not present in an input image. In such a case, instead of an object to which the focus point is preferentially given, the focus point may be set on an object closest to the center of or a point of interest in the input image.

For example, on the assumption that it is set that the focus point is preferentially given to a flower, a flower is not present as an object in the example illustrated in FIG. 4F. In such a case, as in the example illustrated in FIG. 4I, the focus point may be set on the detection frame 413 of the vehicle 412 closest to a center 416 of the input image 411.

In step S105, based on a correction operation received from the user, the operation unit 204 corrects the focus point set by the inference unit 202, and acquires the result of the correction as correction information.

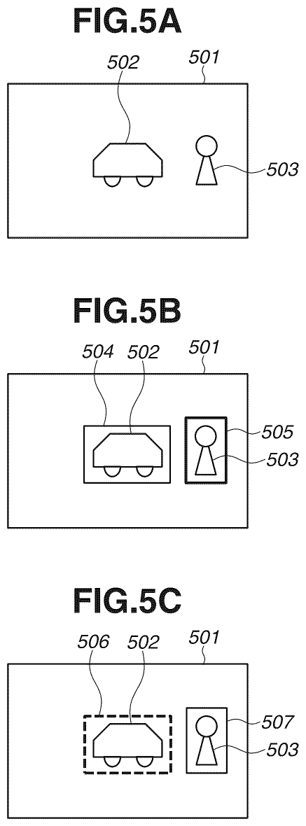

In the example illustrated in FIG. 5A, a vehicle 502 and a person 503 are captured as objects in an input image 501. The example illustrated in FIG. 5B is an example of display in a case where the vehicle 502 and the person 503 illustrated in FIG. 5A are detected, and the focus point is set on the person 503.

Assume that the user is attempting to focus on not the person 503 but the vehicle 502 based on the above premise. In this case, for example, the user may reset the focus point on the vehicle 502 as in the example illustrated in FIG. 5C by operating the cursor keys. If the focus point obtained by the inference unit 202 is thus corrected before and after the cursor key operation of the user, the operation unit 204 generates correction information indicating the focus point after the correction.

In the example illustrated in FIG. 5C, a detection frame 506 on which the focus point is corrected by the user is displayed by a display method different from that for a detection frame 504 in the example illustrated in FIG. 5B to indicate that the focus point is corrected. Specifically, in the example illustrated in FIG. 5C, the detection frame 506 is displayed with a thick dashed line. Although in the examples illustrated in FIGS. 5A to 5C, the display methods for the detection frame 505 and the detection frame 507 are different between the example illustrated in FIG. 5B and the example illustrated in FIG. 5C, the same display method may be applied.

Assume that in the state illustrated in FIG. 5C, the user returns the focus point to the detection frame 505 corresponding to the person 503 by operating the cursor keys, whereby the state illustrated in FIG. 5C returns to the state illustrated in FIG. 5B. In this case, as a result, the focus point is not moved (the focus point is not corrected). If the focus point obtained by the inference unit 202 is thus not corrected before and after the cursor key operation of the user, the operation unit 204 does not generate correction information.

As described above, in the imaging apparatus 10 according to the present embodiment, the inference unit 202 detects an object in an input image and sets a focus point based on the detection result of the object. If the focus point is set at a location different from a location intended by the user based on such a premise, the user may correct an inference result of the inference unit 202. Such control is applied, whereby it is possible to reduce the burden on the user regarding the generation of learning data, for example, compared to a case where the user sets an area of an object in an input image and assigns an annotation indicating a focus point to this area.

### (Learning Process)

An example of a learning process on an inference model in the imaging apparatus according to the first embodiment of the present disclosure is described below.

The learning unit 206 executes a learning process by updating a local inference parameter stored in the inference unit 202 based on an input image acquired by the input unit 201 and correction information acquired by the operation unit 204. Processing regarding the update of the local inference parameter is described below taking as an example a case where an inference model as a target of the learning process is a neural network.

First, based on an input image, an inference model, and a local inference parameter, the learning unit 206 acquires an inference result by a method similar to that of the inference unit 202. The input image applied at this time is an image in the state where correction information associated with the image is present.

Next, using the correction information associated with the input image used to acquire the inference result as supervised data, the learning unit 206 obtains the difference between the correction information and the inference result, and calculates a loss value using a loss function based on the difference.

Then, based on the calculated loss value, the learning unit 206 updates the local inference parameter of the neural network by an error backpropagation method, thereby acquiring the updated inference parameter.

From this point onward, the acquisition of an inference result by the method similar to that of the inference unit 202 based on the input image, the inference model, and the inference parameter after the update, the calculation of a loss value based on the inference result, and an update of the inference parameter based on the loss value are repeated until the loss value is less than or equal to a threshold set in advance. Then, if the loss value is less than or equal to the threshold set in advance, the learning unit 206 stops the update process on the inference parameter, and outputs the updated inference parameter of the neural network when the update process is stopped, as a learning result to the inference unit 202.

The inference unit 202 receives the learning result (the inference parameter after the update) from the learning unit 206 and replaces a local inference parameter stored in the inference unit 202 with the learning result.

As the loss function, a variety of known loss functions can be used. Examples of the loss function include the mean squared error (MSE), the mean absolute error (MAE), binary cross-entropy, and the like.

The learning unit 206 may update all local inference parameters, or may update some of the local inference parameters.

The learning unit 206 may further process the inference parameter obtained as the learning result by performing an operation such as quantization or the like. Such processing is performed, whereby it is possible to execute an inference process at high speed.

It is desirable that the update of the local inference parameter by the inference unit 202 be executed, for example, at a timing when the imaging process illustrated in FIG. 3 is not being performed. This is because there is a possibility that the inference result in step S102 and the accuracy determination process in step S107 become inconsistent in a case where the local inference parameter stored in the inference unit 202 is replaced while the processing illustrated in FIG. 3 is being executed. Thus, if the processing illustrated in FIG. 3 is being executed, it is desirable that the update of the local inference parameter be executed after the execution of the processing ends.

The update of the local inference parameter may be executed in a case where the processing illustrated in FIG. 3 is not executed for a certain time, or the timing of the update may be indicated by the user. Examples of the indication of the timing of the update include the pressing of an update button, the powering off of the imaging apparatus 10, the pressing of a transfer start button for transferring a photograph stored in the imaging apparatus 10 to an external apparatus, and the like. The progress rate of the learning process of the learning unit 206 or the rate of change in the local inference parameter involved in the learning process may be displayed on the output unit 15, and if the progress rate or the rate of change reaches a threshold set in advance, display urging the user to update the local inference parameter may be performed.

The learning process of the learning unit 206 can be executed independently of the processing in FIG. 3, and therefore, the learning process may be executed in parallel with the processing illustrated in FIG. 3. If, on the other hand, the processing load of the entirety of the imaging apparatus 10 is high during the execution of the processing in FIG. 3, the amount of processing of the learning process may be decreased, or the learning process may be temporarily stopped.

If the inference unit 202 receives the learning result from the learning unit 206, the inference unit 202 may save a copy (in other words, a backup) of the local inference parameter stored in the inference unit 202 and then replace the local inference parameter stored in the inference unit 202 with the learning result (the inference parameter after the update). Consequently, in a situation where an inference result obtained after the local inference parameter stored in the inference unit 202 is replaced with the learning result is not desirable, or the like, the inference unit 202 can also replace the local inference parameter stored in the inference unit 202 with the saved local inference parameter. By thus using the local inference parameter saved in advance, the inference unit 202 can restore the local inference parameter before the update in a case where a predetermined condition is satisfied.

### (Communication Process)

A description is given of an example of a communication process in a case where the imaging apparatus 10 including the communication unit 207 as illustrated in FIG. 2B is applied as the imaging apparatus according to the present embodiment.

In the case of the configuration in which the imaging apparatus 10 includes the communication unit 207 as illustrated in FIG. 2B, the communication unit 207 transmits the local inference parameter stored in the inference unit 202 and the accuracy determination result acquired by the accuracy determination unit 205 to the outside (e.g., an external apparatus such as a server or the like).

The communication unit 207 also receives a global inference parameter regarding the inference model from outside. “Global” in the global inference parameter is used in the sense that the inference parameter is derived from outside the imaging apparatus 10.

If the communication unit 207 receives the global inference parameter, the inference unit 202 replaces the local inference parameter stored in the inference unit 202 with the global inference parameter received by the communication unit 207.

The transmission and reception of the above various pieces of information by the communication unit 207 can be independently executed without depending on the imaging process illustrated in FIG. 3. Thus, for example, the transmission and reception may be executed at any timing regardless of whether the imaging process is being executed. On the other hand, it is desirable that the replacement of the inference parameter be executed at a timing when the imaging process illustrated in FIG. 3 is not being executed. This is because there is a possibility that the inference result in step S102 and the accuracy determination process in step S107 become inconsistent in a case where the local inference parameter stored in the inference unit 202 is replaced while the processing illustrated in FIG. 3 is being executed. Thus, if the processing illustrated in FIG. 3 is being executed, it is desirable that the replacement process on the inference parameter by the inference unit 202 be executed after the execution of the processing ends.

The replacement of the local inference parameter may be executed in a case where the processing illustrated in FIG. 3 is not executed for a certain time, or the timing of the replacement may be indicated by the user.

If the communication unit 207 receives a plurality of global inference parameters in a situation where the processing illustrated in FIG. 3 continues, the communication unit 207 may hold the newest global inference parameter and discard the other old global inference parameters.

### First Variation of First Embodiment

### (Detection and Correction of Scene)

Although in the first embodiment, a description has been given of an example of a case where the correction of a focus point is applied as correction information, the correction information is not limited to this example, and the correction of other information may be applied. As a specific example, the correction of a scene detection result in an input image, such as a portrait or a scenery, may be applied as correction information.

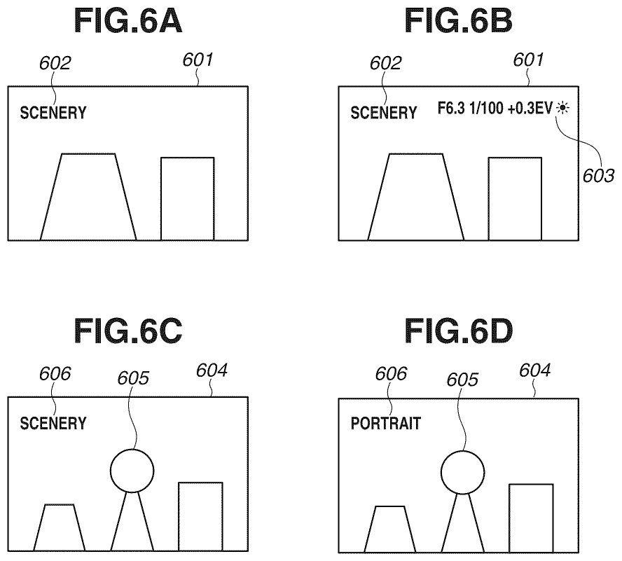

In the present variation, with reference to FIGS. 6A to 6D, the details of the processes of steps S102 and S105 are described taking as an example a case where in an image captured according to an instruction from the user, a scene detection result of the imaging apparatus 10 is corrected by an operation of the user.

In step S102, the inference unit 202 detects from an input image a scene of the input image. The presentation unit 203 visualizes the detection result, superimposes the detection result on the input image, and then outputs the resulting image to the output unit 15, thereby presenting the resulting image to the user. Examples of the scene include a portrait, a group photograph, a scenery, a sport, a close-up, a food, a night view, a night view portrait, a handstored night view, backlight correction, and the like.

In the example illustrated in FIG. 6A, a scene detection result in an input image 601 is visualized as character information 602 and displayed. Although in the example illustrated in FIG. 6A, the scene detection result is displayed in text, an icon reminiscent of each scene may be displayed, or the combined display of the text and the icon may be applied.

If the scene detection result is obtained, various imaging parameters may be adjusted so that optimal imaging conditions are applied to the detected scene. Examples of the imaging parameters include the exposure, the white balance, the stop, the shutter speed, the focal length, color correction, contrast correction, the presence or absence of a close-up mode, the presence or absence of a neutral density filter, the presence or absence of the light emission of a flash, the light emission amount of the flash, the light emission timing of the flash, and the like.

If the imaging parameters of the imaging apparatus 10 are adjusted for the detected scene, then as in the example illustrated in FIG. 6B, imaging parameters 603 may be displayed in addition to the scene detection result 602 in the input image 601. In the example illustrated in FIG. 6B, the stop “F6.3”, the shutter speed “ 1/100”, the exposure compensation “+0.3 EV”, and a sun icon meaning white balance sunny weather are displayed.

In step S105, based on a correction operation received from the user, the operation unit 204 corrects the scene set by the inference unit 202 (the scene obtained as an inference result of the inference model), and acquires the result of the correction as correction information.

For example, assume that in the example illustrated in FIG. 6C, a scene detection result 606 is the scenery in a case where a person 605 is captured in an input image 604. In contrast, the user intends not the scenery but the portrait as the scene. In this case, for example, the user may change the scene to the portrait as in the example illustrated in FIG. 6D by operating the cursor keys. If the scene detection result obtained by the inference unit 202 is thus corrected before and after the cursor key operation of the user, the operation unit 204 generates correction information indicating the scene after the correction.

Assume that in the state illustrated in FIG. 6D, the user returns the scene to the scenery by operating the cursor keys, whereby the state illustrated in FIG. 6D returns to the state illustrated in FIG. 6C. In this case, as a result, the scene is not changed. If the scene detection result obtained by the inference unit 202 is thus not corrected before and after the cursor key operation of the user, the operation unit 204 does not generate correction information.

Although a change in the scene has been described in the present variation, an idea similar to the above is applicable so long as inference can be performed and a presented inference result can be corrected by a user operation. Thus, the target of the inference or the correction is not limited to the focus point or the scene.

### Second Variation of First Embodiment

As the imaging apparatus according to the above embodiment, various types of imaging apparatuses are applicable. Specific examples of the imaging apparatus include an interchangeable lens camera, a mirrorless camera, a network camera, and the like.

The imaging apparatus is not limited to a so-called camera, and for example, may be a mobile terminal equipped with a camera, such as a smartphone, a tablet terminal, a laptop personal computer, or the like.

Examples of another apparatus that can be applied as the imaging apparatus include apparatuses, such as a personal computer, a server, an edge terminal, and the like, capable of receiving an image from an imaging apparatus such as an external camera, a network camera, or the like (i.e., an apparatus with an imaging unit provided outside). In this case, the imaging unit 17 may not necessarily be mounted on the apparatus.

In this case, the apparatus that achieves the processing of the components illustrated in each of FIGS. 2A and 2B corresponds to an example of the information processing apparatus according to the present embodiment.

### Second Embodiment

As a second embodiment of the present disclosure, an example of a federated learning system including one or more imaging apparatuses (the imaging apparatus according to the first embodiment) and a server is described.

### (Hardware Configuration of Server)

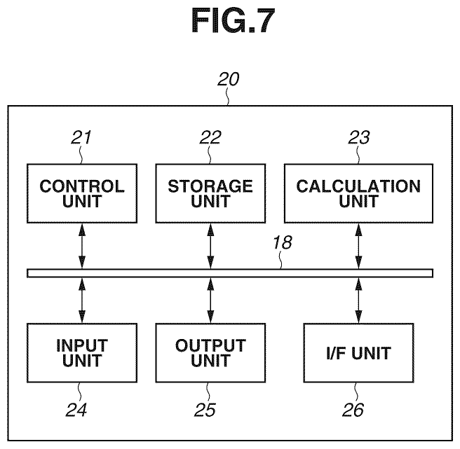

With reference to FIG. 7, an example of the hardware configuration of the server applied to the federated learning system according to the present embodiment is described. A server 20 includes a control unit 21, a storage unit 22, a calculation unit 23, an input unit 24, an output unit 25, an I/F unit 26, and a system bus 27 as the hardware configuration.

The control unit 21 controls the entirety of the server 20.

The storage unit 22 holds a program and data for achieving the operation of the control unit 21.

The calculation unit 23 executes various calculation processes based on control of the control unit 21. As the calculation unit 23, for example, a CPU, a GPU, a TPU, a VPU, or the like can be applied.

The input unit 24 receives the input of a user operation on the server 20. As the input unit 24, for example, a mechanical switch, a touch panel, a human interface device, or the like can be applied.

The output unit 25 presents information regarding the processing result of the server 20 or the like to the user. As the output unit 25, for example, a display or the like can be applied.

The I/F unit 26 corresponds to an interface with outside used to receive programs, data, and the like for achieving various operations of the server 20 from outside or transmit various pieces of information regarding the processing result obtained by the server 20 and the like to outside. Examples of the I/F unit 26 include wired interfaces compliant with various standards such as USB, Ethernet, an optical fiber cable, and the like. As the I/F unit 26, wireless interfaces compliant with various standards Wi-Fi, Bluetooth®, and the like may be applied.

The control unit 21, the storage unit 22, the calculation unit 23, the input unit 24, the output unit 25, and the I/F unit 26 are connected together via the system bus 27 so that these units can transmit and receive information to and from each other.

### (Federated Learning System)

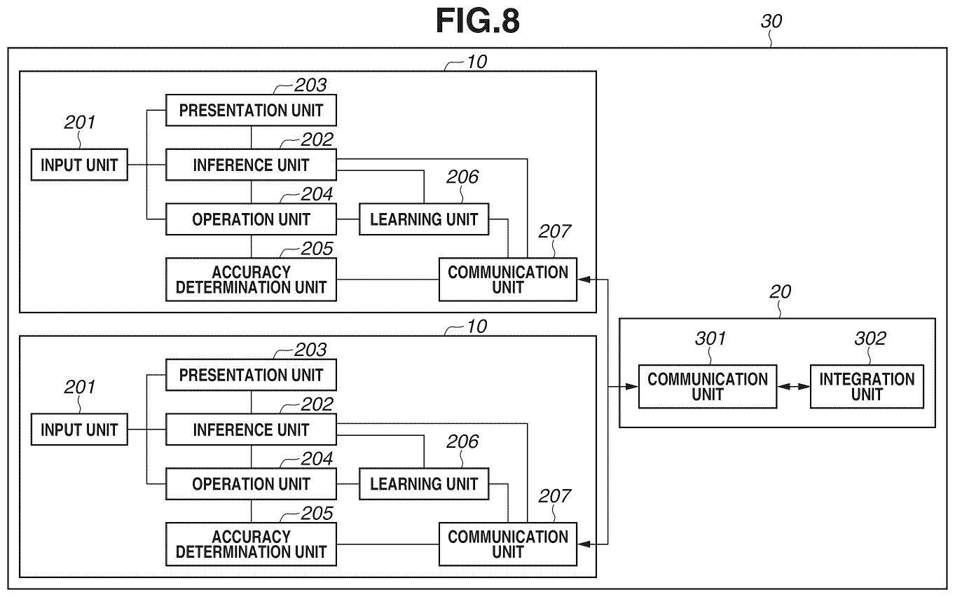

With reference to FIG. 8, an example of the functional configuration of the federated learning system according to the present embodiment is described. A federated learning system 30 illustrated in FIG. 8 includes two imaging apparatuses 10 and a single server 20. The functional configuration of each imaging apparatus 10 is substantially similar to that of the imaging apparatus 10 according to the first embodiment described with reference to FIG. 2B, and therefore is not described in detail.

The server 20 includes a communication unit 301 and an integration unit 302.

The integration unit 302 holds a global inference parameter.

The communication unit 301 transmits the global inference parameter stored in the integration unit 302 to each imaging apparatus 10. The global inference parameter at this time is in the state before the imaging apparatus 10 performs a learning process.

The communication unit 301 also receives a local inference parameter stored in the inference unit 202 and an accuracy determination result obtained by the accuracy determination unit 205 from the imaging apparatus 10. The local inference parameter at this time is in the state after the imaging apparatus 10 performs an additional learning process using the global inference parameter as an initial value.

The integration unit 302 receives from the communication unit 301 the local inference parameters and the accuracy determination results received by the communication unit 301 from the one or more imaging apparatuses 10. The integration unit 302 integrates the local inference parameters based on the accuracy determination results, thereby updating the global inference parameter.

Although in the example illustrated in FIG. 8, a case has been described where two imaging apparatuses 10 are included, the configuration of the federated learning system according to the present embodiment is not limited to this. For example, three or more imaging apparatuses 10 may be included.

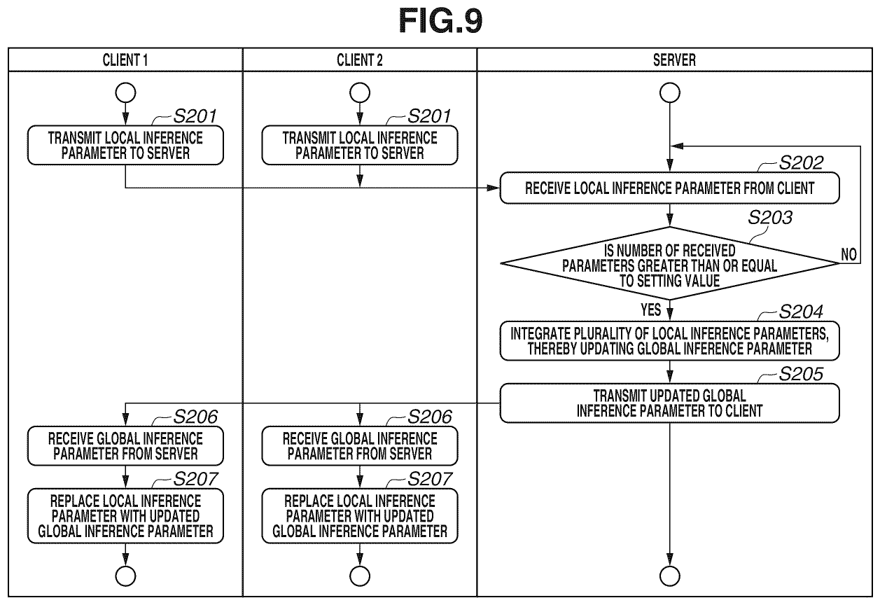

With reference to FIG. 9, an example of the processing of the federated learning system 30 according to the present embodiment is described. An imaging process of each imaging apparatus 10 is substantially similar to that in the example described with reference to FIG. 3. In the example illustrated in FIG. 9, the flow of the processing of the server 20 and the flow of the processing of communication between each imaging apparatus 10 and the server 20 are described.

In step S201, each imaging apparatus 10 transmits a local inference parameter stored in the inference unit 202 of the imaging apparatus 10 and an accuracy determination result by the accuracy determination unit 205 to the server 20 via the communication unit 207. A variety of known communication protocols can be used for communication between the imaging apparatus 10 and the server 20. Specific examples of the known communication protocols include Hypertext Transfer Protocol (HTTP) and gRPC Remote Procedure Calls (gRPC).

When the communication unit 207 transmits the local inference parameter and the accuracy determination result to the server 20, the communication unit 207 may apply encrypted communication. To the encrypted communication, a variety of known methods are applicable. Examples of the known methods include Secure Sockets Layer (SSL), Transport Layer Security (TLS), and the like.

For example, the imaging apparatus 10 may transmit the local inference parameter and the accuracy determination result to the server 20 at the timing when a learning process of the learning unit 206 ends. As another example, the imaging apparatus 10 may receive an operation of the user and transmit the local inference parameter and the accuracy determination result to the server 20. Examples of the operation of the user include the pressing of a “transmit to server” button, the powering off of the imaging apparatus 10, the pressing of a transfer start button for transferring an image stored in the imaging apparatus 10 to an external apparatus, and the like.

Examples of the configuration of information when the imaging apparatus 10 transmits the local inference parameter and the accuracy determination result to the server 20 include configurations illustrated below.
Information certifying the transmission source (e.g., an Internet Protocol (IP) address, a medium access control (MAC) address, a model name, a serial number, a name, an identifier (ID) issued by a server, a digital signature, or a public key)
The local inference parameter (e.g., if the inference model is a neural network, a weight coefficient, a bias value, or the like of the neural network)
The accuracy determination result (e.g., the value of p given by expression 1)

The information certifying the transmission source is assigned, whereby it is possible to prevent the occurrence of a situation where an unintended imaging apparatus transmits a local inference parameter and an accuracy determination result to the server 20.

In step S202, the server 20 receives the local inference parameter and the accuracy determination result from the imaging apparatus 10 via the communication unit 301. The communication unit 301 receives the local inference parameter and the accuracy determination result using the communication protocol used by the communication unit 207 of the imaging apparatus 10. If the communication unit 207 uses encrypted communication, the communication unit 301 decrypts the received local inference parameter and accuracy determination result according to a similar encrypted communication method.

If the information certifying the transmission source is assigned to the local inference parameter and the accuracy determination result, the server 20 verifies the information certifying the transmission source. If the information does not pass the verification, the server 20 may discard the received local inference parameter and accuracy determination result. If the information certifying the transmission source that is to be assigned to the local inference parameter and the accuracy determination result is not assigned, the server 20 may discard the received local inference parameter and accuracy determination result.

If the server 20 receives two or more local inference parameters and two or more accuracy determination results from the same imaging apparatus 10, for example, the server 20 may hold the newest information and discard the other old information. As another example, the server 20 may save the plurality of local inference parameters and accuracy determination results by assigning a reception history record to each of the local inference parameters and the accuracy determination results. In this case, control may be applied so that the upper limit of the number of history records that can be saved is set, and history records exceeding the upper limit are discarded in chronological order.

If the transmission from the imaging apparatus 10 fails, or if the transmission from the imaging apparatus 10 is not performed, the communication unit 301 does not perform the reception operation.

In step S203, the communication unit 301 manages the numbers of received local inference parameters and accuracy determination results and determines whether the numbers of received local inference parameters and accuracy determination results are greater than or equal to a setting value.

If the communication unit 301 determines in step S203 that the numbers of received local inference parameters and accuracy determination results are greater than or equal to the setting value (YES in step S203), the processing proceeds to step S204.

If, on the other hand, the communication unit 301 determines in step S203 that the numbers of received local inference parameters and the accuracy determination results are less than the setting value (NO in step S203), the processing returns to step S202. In this case, the communication unit 301 continues to receive a local inference parameter and an accuracy determination result from the imaging apparatus 10 until the numbers of received local inference parameters and accuracy determination results are greater than or equal to the setting value.

As the setting value, an integer value greater than or equal to 1 is set. The reason why the minimum value of the setting value is 1 is that if the communication unit 301 does not receive a local inference parameter and an accuracy determination result, an update process on a global inference parameter in and after step S204 cannot be performed, and therefore, the execution of the update process is suppressed.

As the setting value, for example, the same value as the number of imaging apparatuses 10 may be set. As a specific example, if there are two imaging apparatuses 10 as illustrated in FIG. 7, 2 may be applied as the setting value. In this case, if the server 20 receives a local inference parameter and an accuracy determination result from each of the two imaging apparatuses 10 indicated as clients 1 and 2, the server 20 executes an update process on a global inference parameter in step S204 and subsequent steps.

If the number of imaging apparatuses 10 is very large, for example, a situation can also be assumed where it is difficult for the server 20 to receive local inference parameters and accuracy determination results from all the imaging apparatuses 10, for example, because some of the imaging apparatuses 10 are in stop states and have difficulty communicating with the server 20. If such a situation can be assumed, for example, the server 20 may set the setting value to a value less than the number of imaging apparatuses 10, and at the time when as many local inference parameters and accuracy determination results as the number of the setting value are received, an update process on a global inference parameter in and after step S204 may be executed.

If the server 20 receives local inference parameters and accuracy determination results multiple times from the same imaging apparatus 10, the reception performed multiple times may be counted as one time so long as the local inference parameters and the accuracy determination results are from the same imaging apparatus 10. Or the number of times of reception may be counted. For example, if the server 20 receives local inference parameters and accuracy determination results three times, the reception may be counted as three times. If the number of imaging apparatuses 10 is very large, a situation can also be assumed where it is cumbersome to manage the number of times of reception with respect to each imaging apparatus 10. If such a situation can be assumed, for example, the number of times of reception is simply counted, whereby it is also possible to eliminate the need to manage the number of times of reception with respect to each imaging apparatus 10 and simplify processing.

In step S204, the integration unit 302 integrates the local inference parameters based on the accuracy determination results received in step S202, thereby updating a global inference parameter stored in the integration unit 302. For the integration of the inference parameters, a variety of known methods can be used. Examples of the known methods include a method known as aggregation. Other examples of the known methods include Federated Averaging (FedAvg), the geometric median, the coordinate-wise median, the trimmed mean, and the like.

When the local inference parameters are integrated, weights based on the accuracy determination results are applied, whereby it is possible to integrate the local inference parameters based on the accuracy determination results. Although an example of the method for integrating the inference parameters based on FedAvg is described below, a similar idea can also be applied to another method.

In FedAvg, K imaging apparatuses are randomly sampled from all the imaging apparatuses, and the average value of updated local inference parameters of the sampled K imaging apparatuses is taken, thereby updating the global inference parameter. A relational expression regarding the update of the global inference parameter is illustrated below as expression 2.

$${θ}_{r} = \frac{1}{K} {\sum }_{i ∈ S} {θ}_{i , t} \qquad ( expression 2 )$$

In expression 2, θₜ represents a t-th component of a global inference parameter θ after the update. θ_{i,t} represents a t-th component of a local inference parameter θᵢ of an imaging apparatus i. S represents a set of randomly sampled imaging apparatuses. K represents the number of imaging apparatuses included in S.

When the average value is taken, the weighted average can be calculated by using a weight wᵢ regarding each imaging apparatus i as illustrated below in expression 3.

$${θ}_{t} = \frac{1}{K} {\sum }_{i ∈ S} {w}_{i} {θ}_{i , t} \qquad ( expression 3 )$$

As an example of the weighting, a description is given below of a case where an accuracy determination result is calculated based on the example described as the process of step S107 illustrated in FIG. 3 in the first embodiment, i.e., a case where the imaging operation is performed N times and the number of times of the imaging operation involving correction is M times out of N times. In the first embodiment, a case where the accuracy determination result p satisfies expression 1, i.e., a case where p=(N−M)/N, has been considered. In this case, the smaller the number of operations involving correction is, the greater the accuracy determination result p is.

The accuracy determination result p of the imaging apparatus i is defined as pᵢ, and the weight wᵢ is to be obtained based on a relational expression illustrated below as expression 4.

$${w}_{i} = {p}_{i} / {\sum }_{i ∈ S} {p}_{i} \qquad ( expression 4 )$$

Expression 4 corresponds to a method for integrating local inference parameters by applying a greater weight to a local inference parameter for which fewer operations involving correction are performed. This method is more suitable for a case where update information is incorporated without greatly changing the content of the global inference parameter. For example, this can correspond to a case where the inference unit 202 can appropriately perform inference in many cases, but an inference result is rarely corrected in an inappropriate case.

On the other hand, the accuracy determination result p of the imaging apparatus i is defined as pᵢ, and the weight wᵢ is obtained based on a relational expression illustrated below as expression 5.

$${w}_{i} = ( 1 - {p}_{i} ) / {\sum }_{i ∈ S} ( 1 - {p}_{i} ) \qquad ( expression 5 )$$

Expression 5 corresponds to a method for integrating local inference parameters by applying a greater weight to a local inference parameter in which more operations involving correction are performed. This method is more suitable for a case where update information from the imaging apparatus is positively incorporated into the global inference parameter in the state where the inference accuracy is insufficient. Specifically, this can correspond to a case where it is difficult for the inference unit 202 to appropriately perform inference in many cases, and therefore, it is desirable that a correction operation of the user be positively incorporated.

The integration unit 302 may update all global inference parameters stored in the integration unit 302, or may update some of the global inference parameters.

In step S205, the server 20 transmits the global inference parameter updated by the integration unit 302 to each imaging apparatus 10 via the communication unit 301. To the transmission of the global inference parameter to the imaging apparatus 10, the variety of known communication protocols described in step S201 can be applied. When the communication unit 301 transmits the global inference parameter to the imaging apparatus 10, the communication unit 301 may apply encrypted communication. To the encrypted communication, the variety of known methods described in step S201 can be applied.

When the server 20 transmits the global inference parameter to each imaging apparatus 10, the server 20 may receive from the imaging apparatus 10 a reception notification indicating that the global inference parameter is received. In such a case, the server 20 may transmit the global inference parameter again to an imaging apparatus 10 from which the server 20 fails to receive the reception notification within a period determined in advance.

If, on the other hand, the number of imaging apparatuses 10 is very large, for example, there is a case where it is difficult for the server 20 to receive the reception notification from all the imaging apparatuses 10, for example, because some of the imaging apparatuses 10 are in stop states and have difficulty communicating with the server 20. In such a case, the server 20 may set the upper limit of the number of times of transmission of the global inference parameter and stop the transmission of the global inference parameter to an imaging apparatus 10 that reaches the upper limit. After the transmission of the global inference parameter to a certain imaging apparatus 10 is stopped, and if the communication with the imaging apparatus 10 is recovered, the server 20 may transmit the global inference parameter again at this timing.

In step S206, the imaging apparatus 10 receives the global inference parameter from the server 20 via the communication unit 207. The communication unit 207 receives the global inference parameter according to the communication protocol used to transmit the global inference parameter by the communication unit 301 of the server 20. If the communication unit 301 uses encrypted communication, the communication unit 207 decrypts the received global inference parameter in accordance with a similar encrypted communication method.

If the imaging apparatus 10 receives two or more global inference parameters from the server 20, for example, the imaging apparatus 10 may hold the newest information and discard the other old information.

If the transmission from the server 20 fails, or if the transmission from the server 20 is not performed, the communication unit 207 does not perform the reception operation.

In step S207, the imaging apparatus 10 sends to the inference unit 202 the global inference parameter received from the server 20 via the communication unit 207. The inference unit 202 updates the local inference parameter stored in the inference unit 202 to the global inference parameter. At this time, the inference unit 202 may update all local inference parameters stored in the inference unit 202, or may update some of the local inference parameters. As the update method for the inference parameter, a method similar to the method described in the first embodiment can be applied.

As described above, according to the present embodiment, it is possible to realize, in a more suitable manner, the training of an inference model using data stored by each client, i.e., federated learning, through cooperation between a server and one or more clients, without disclosing the data itself. It is also possible to reduce the burden on a user regarding the generation of learning data compared to a case where the user sets a portion (e.g., an area of an object) as a target of inference in data as a target (e.g., an input image) and assigns an annotation to this portion.

### OTHER EMBODIMENTS

The present disclosure can also be implemented by supplying a program that realizes one or more of the functions of the above-described embodiments to a system or apparatus via a network or a storage medium, and by having one or more processors of a computer in the system or apparatus read and execute the program. Furthermore, it can also be implemented by a circuit (for example, an Application-Specific Integrated Circuit (ASIC)) that realizes one or more of the functions.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-014926, filed Jan. 31, 2025, which is hereby incorporated by reference herein in its entirety.

What is claimed is:

1. An information processing apparatus comprising:
at least one processor; and
at least one memory having instructions stored therein which, when executed by the at least one processor, cause the information processing apparatus to:
acquire an input image;
store an inference model and a local inference parameter to be applied to the inference model, and acquire an inference result from the inference model by inputting the acquired input image to the inference model and applying the local inference parameter thereto;
acquire, from a user, correction information representing a correction result that corrects the inference result; and
execute a learning process on the inference model based on the input image and the correction information.

2. The information processing apparatus according to claim 1, wherein execution of the stored instructions further configures the at least one processor to
acquire an accuracy determination result by determining an accuracy of the stored local inference parameter based on the inference result and the correction information.

3. The information processing apparatus according to claim 1,
wherein execution of the stored instructions further configures the at least one processor to:
transmit, to an external apparatus, the stored local inference parameter, and receive from the external apparatus, a global inference parameter regarding the inference model that has been generated at the external apparatus based on local inference parameters provided by a plurality of information processing apparatuses, and
in response to the reception of the global inference parameter, the stored local inference parameter is updated to the global inference parameter.

4. The information processing apparatus according to claim 2,
wherein the execution of the stored instructions further configures the at least one processor to:
transmit, to an external apparatus, the local inference parameter and the accuracy determination result;
receive from the external apparatus, a global inference parameter regarding the inference model, that has been generated at the external apparatus based on local inference parameters and the accuracy determination results provided by a plurality of information processing apparatuses; and
in response to the reception of the global inference parameter, the stored local inference parameter is updated to the global inference parameter.

5. The information processing apparatus according to claim 2, wherein the correction information includes the accuracy determination result and is acquired based on a frequency at which the inference result is corrected.

6. The information processing apparatus according to claim 2,
wherein the inference model is a model configured to infer a focus point based on a position of an object as a target in the input image, and
wherein the correction information includes the accuracy determination result and is acquired based on a frequency at which the focus point is corrected.

7. The information processing apparatus according to claim 2,
wherein the inference model is a model configured to infer a scene of the input image, and
wherein the correction information includes the accuracy determination result and is acquired based on a frequency at which the scene is corrected.

8. The information processing apparatus according to claim 1,
wherein before the local inference parameter is updated based on a result of the learning process on the inference model, a copy of the stored local inference parameter is saved, and
wherein after the local inference parameter is updated based on the result of the learning process on the inference model, the local inference parameter before update is restored by replacing the updated local inference parameter with the saved copy of the local inference parameter.

9. The information processing apparatus according to claim 1, wherein in a case where the local inference parameter is updated by performing the learning process on the inference model based on the input image and the correction information, a part of the local inference parameter is updated.

10. The information processing apparatus according to claim 1, wherein the input image and the inference result are presented to the user.

11. An information processing method comprising:
acquiring an input image;
storing an inference model and a local inference parameter to be applied to the inference model, and acquiring an inference result from the inference model by inputting the acquired input image to the inference model to which the local inference parameter is applied;
acquiring, from a user, correction information representing a correction result the inference result; and
executing a learning process on the inference model based on the input image and the correction information.

12. A non-transitory computer-readable storage medium having stored thereon a program for causing a computer to function as:
an input unit configured to acquire an input image;
an inference unit configured to store an inference model and a local inference parameter to be applied to the inference model, and acquire an inference result from the inference model by inputting the acquired input image to the inference model to which the local inference parameter is applied;
a reception unit configured to acquire, from a user, correction information representing a correction result that corrects the inference result; and
a learning unit configured to execute a learning process on the inference model based on the input image and the correction information.

13. A system comprising:
an information processing apparatus comprising:
at least one processor; and
at least one memory having instructions stored therein which, when executed by the at least one processor, cause the information processing apparatus to:
acquire an input image;
store an inference model and a local inference parameter to be applied to the inference model, and acquire an inference result from the inference model by inputting the acquired input image to the inference model and applying the local inference parameter;
acquire, from a user, correction information representing a correction result that corrects the inference result; and
execute a learning process on the inference model based on the input image and the correction information; and
an external apparatus including at least one processor configured to:
receive local inference parameters from the information processing apparatus and from one or more additional information processing apparatuses;
integrate the received local inference parameters to generate an updated global inference parameter; and
transmit the updated global inference parameter to the information processing apparatuses.

14. The system according to claim 13,
wherein, in the information processing apparatus, execution of the stored instructions further configures the at least one processor to acquire an accuracy determination result by determining an accuracy of the stored local inference parameter based on the inference result and the correction information, and
wherein the external apparatus including at least one processor is further configured to:
store a global inference parameter; receive local inference parameters and corresponding accuracy determination results from a plurality of information processing apparatuses;
integrate the received local inference parameters based on the accuracy determination results to generate an updated global inference parameter; and
transmit the updated global inference parameter to the plurality of information processing apparatuses.
